(19) United States
(12) Patent Application Publication
(10) Pub. No.: US 2023/0217912 A1
(43) Pub. Date: Jul. 13, 2023

(54) DEVICE FOR INTERCEPTING CRAWLING INSECTS, AND FURNITURE AND BED PROVIDED WITH SUCH A DEVICE

(71) Applicant: LE MATELAS 365, Lagny sur Marne (FR)

(72) Inventor: Pascal HUGER, Lagny sur Marne (FR)

(21) Appl. No.: 17/928,199

(22) PCT Filed: May 27, 2021
(86) PCT No.: PCT/EP2021/064240

§ 371 Date: Nov. 28, 2022

(30) Foreign Application Priority Data
May 28, 2020 (FR) FR2005631

(51) Int. Cl. A01M 1/14; A01M 1/10

(52) U.S. Cl. CPC A01M 1/14; A01M 1/103

(57) ABSTRACT

A device for intercepting crawling insects includes at least one body. The body includes a base for resting against a piece of furniture and having a hole at its center; a first skirt extending from the base so as to form a circumferentially closed side wall; a second skirt surrounding the first skirt externally so that an outer periphery of the side wall faces an inner periphery of the second skirt; and at least one sticky strip arranged on the outer periphery of the side wall or on the inner periphery of the second skirt.

The invention relates to the field of parasite management, and more particularly to a device for intercepting crawling insects such as bedbugs, ants, cockroaches, . . . . The invention also relates to a piece of furniture fitted with such a device and to a bed fitted with such a device.

### BACKGROUND OF THE INVENTION

Although bedbugs disappeared shortly after the World War II as a result of using the insecticide DDT (dichlorodipenyltrichloroethane), a considerable increase in these insects has been observed throughout the world over the last decade.

Adult bedbugs are 4 millimeters (mm) to 7 mm long, and their legs are provided with hooks that enable them to climb on any fibrous or rough surface. Nevertheless, they are not capable of jumping or flying.

Bedbugs feed almost exclusively on human blood, they shy away from light, and they are active mostly at night, being attracted by the warmth of our bodies and the carbon dioxide we exhale. They prefer places where they can hide easily and feed regularly, and in particular beds. That flat bodies enable them to hide in very small spaces, in particular inside bed frames and mattress covers. It is therefore difficult to detect their presence in living quarters and thus to prevent them from developing. Also, like most insects, they have a reproductive cycle of a few days with abundant offspring quickly becoming exponential. Their bites and the inflammatory reactions to which they give rise, and also their invasive capacity make them insects that are particularly harmful, requiring intervention as soon as they appear.

It is possible to combat an invasion of bedbugs by insecticide-type chemical treatments that are more or less effective, but that are often also toxic for other inhabitants (humans or pets) and for the environment. In addition, over time, these insects can develop resistance, making such treatments ineffective.

Another solution consists in raising and maintaining the temperature of the zone for treatment to about 55° C. so as to kill bedbugs at all stages in their life cycle. That method is appropriate for people who are sensitive to chemicals, but it is burdensome to prepare and to carry out.

Bedbug-capturing devices are also known that include an attractive substance and a sticky housing on which the attractive substance is placed. The housing is placed on or in the proximity of a bed in order to attract the attention of bedbugs, which, once they have come into contact with the sticky body, can no longer detach themselves therefrom.

There also exist devices comprising cups in which a little diatomaceous earth is placed. When placed under each leg of the bed, they prevent bedbugs from reaching the bed frame and they capture any bedbugs trying to come down.

Although they are found to be relatively effective, both of those devices are particularly conspicuous and unsightly. What's more, diatomaceous earth is particularly volatile and can irritate the nose and the respiratory tract when inhaled.

### OBJECT OF THE INVENTION

An object of the invention is thus to propose a device that is both unobtrusive and ecological for reliably and effectively intercepting crawling insects, while also being easy to install.

### SUMMARY OF THE INVENTION

To this end, there is provided a device for intercepting crawling insects, the device comprising at least one body, itself comprising:

a base for resting against a piece of furniture and having a hole at its center;

a first skirt extending from the base so as to form a circumferentially closed side wall;

a second skirt surrounding the first skirt externally so that an outer periphery of the side wall faces an inner periphery of the second skirt;

at least one sticky strip arranged on the outer periphery of the side wall or on the inner periphery of the second skirt.

Thus, on coming into contact with the sticky strip, any crawling insect moving along the body in order to reach the piece of furniture remains stuck and can no longer detach itself therefrom. Furthermore, by resting against the piece of furniture, the device tends to be visually unobtrusive.

The presence of the second skirt enables the sticky strip to be protected from dust and makes it easier to take hold of the device in the hand while avoiding any physical contact with the sticky strip. The second skirt also serves to hide the bedbugs trapped by the sticky strip out of sight.

In particular manner, the sticky strip is a glue-based strip.

In particular manner, the first and second skirts are cylindrical in shape.

In particular manner, the first and second skirts are spaced apart radially by a distance of not less than 10 mm so as to oblige the crawling insects to cross the sticky strip in order to go from the first skirt to the second skirt.

In a particular embodiment of the invention, the sticky strip is carried by a sleeve attached to the body, making it easier to change the sticky strip and making it easy to check its state (presence of insects, of dust, . . . ).

In particular manner, the sleeve is screwed to the body.

In particular manner, the sleeve is clipped to the body.

According to a particular characteristic, the sleeve is made up of two portions that can be separated.

In particular manner, the two portions of the sleeve are secured to each other temporarily by a mortise-and-tenon assembly.

According to another particular characteristic, a distal end of the sleeve is textured, making it easier to grasp the sleeve, in particular while it is being assembled with the body, or disassembled therefrom.

In particular manner, the device includes a sealing element arranged to provide sealing between the body and an element of the piece of furniture arranged in said body. The sealing element then serves to prevent crawling insects from entering between the body and the element of the piece of furniture arranged in said body.

In particular manner, the device includes a cover closing a free end of the body remote from the base.

According to another particular characteristic, the hole and the first skirt form a cylindrical housing receiving an adapter arranged to enable a first element to be screwed to the body, and enabling the body to be screwed to a second element. For example, the first element may be a bed leg or a raising block, and the second element may be a bed frame.

In particular manner, the adapter comprises a threaded insert for receiving a threaded rod of the first element (P, P′) and from which there extends a threaded rod for screwing to the second element (S, S′).

The invention also proposes a piece of furniture having a face and at least one such device arranged in such a manner that its base rests against the face.

The invention also proposes a bed comprising a frame and at least one bed leg fastened to the frame and having sandwiched between them such a device.

The invention also proposes a bed head having a first face arranged to face a floor, a second face arranged to face a wall, and at least one such device, wherein the device is arranged in such a manner that the base of the body rests against one or the other of the first and second faces.

### BRIEF DESCRIPTION OF THE DRAWINGS

The invention can be better understood in the light of the following description, which description is purely illustrative and nonlimiting, and should be read with reference to the accompanying figures, in which:

FIG. 1 is an axial section view of a device in a first embodiment of the invention, held between a bed frame and a bed leg;

FIG. 2 is an axial section view of a first variant of the device shown in FIG. 1;

FIG. 3 is a plan view of a fastener bracket for fastening the bed leg to the bed frame, seeking to shift said bed leg, and thus also the device shown in FIG. 1, towards the center of the bed frame, in a second variant of the invention;

FIG. 4 is an axial section view of a third variant of the device shown in FIG. 1;

FIG. 5 is a section view of a bed head fitted with a plurality of devices such as that illustrated in FIG. 4;

FIG. 6 is an axial section view of a fourth variant of the device shown in FIG. 1;

FIG. 7 is an axial section view of a device in a second embodiment of the invention, fastened between a bed frame and a raising block;

FIG. 8 is an axial section view of a first variant of the device shown in FIG. 7; and

FIG. 9 is an axial section view of a second variant of the device shown in FIG. 7.

### DETAILED DESCRIPTION OF THE INVENTION

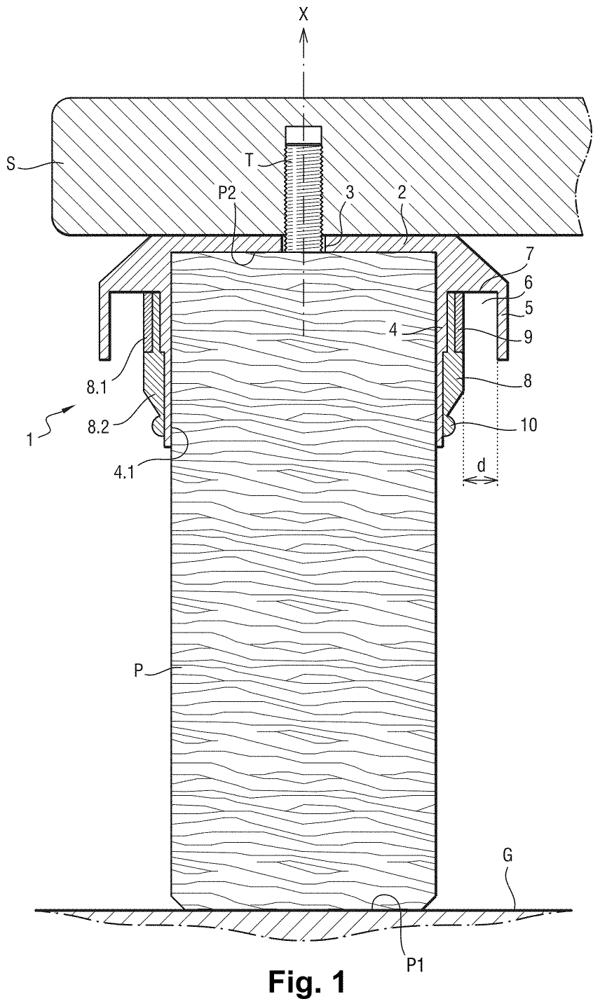

With reference to FIG. 1, the invention is described herein in its application to intercepting bedbugs using a bed leg P for reaching a bed frame S. The leg P is cylindrical in shape and it extends along a vertical axis X. It has a horizontal bottom face P1 for resting on a floor G, and a horizontal top face P2 from which there projects a threaded rod T for screwing into one end of a bar of the bed frame S.

In a first embodiment, the invention provides an interception device comprising a body, given overall reference 1, that is held between the bed leg P and the bed frame S.

The body 1 has a flat base plate 2 of circular shape that extends in a horizontal plane orthogonal to the axis X. At its center, the base 2 has a hole 3 of diameter slightly greater than the diameter of the threaded rod T.

A first skirt 4 of cylindrical shape extends from the base 2 and forms a side wall that is circumferentially closed and coaxial about the axis X. The first skirt 4 has an inside diameter that is slightly greater than the diameter of the leg and it has a free end 4.1 with an outside thread.

A second skirt 5 of cylindrical shape is connected to the base 2 and surrounds the first skirt 4 externally. The first and second skirts 4 and 5 are coaxial and together with the base 2, they define an annular groove 6 having an end wall 7 that is flat and horizontal. Advantageously, the second skirt 5 presents externally a surface state that is smooth so that bedbugs find it difficult to climb and crawl on said second skirt 5. Preferably, at least a portion (but preferably all) of the outside surface of the second skirt 5 is treated to be non-stick so as to limit any climbing and crawling of bedbugs on said second skirt 5 even further. For this purpose, the second skirt 5 in this example is covered in a non-stick coating of Teflon® type.

A sleeve 8 of generally cylindrical shape is screwed onto the first skirt 4 and bears against the end wall 7 of the annular groove 6. The sleeve 8 has a top segment 8.1 carrying on its outside a sticky strip 9, and a bottom segment 8.2 with an inside thread for co-operating with the threaded end 4.1 of the first skirt 4.

By way of example, the sticky strip 9 is a double-sided glue strip having one face coated in weak glue to enable it to be fastened on the top segment of the sleeve, and another face coated in strong glue for trapping bedbugs.

In order to facilitate its replacement, the sticky strip 9 may be made of two portions suitable for being secured to each other temporarily, e.g. via a mortise-and-tenon assembly, so as to surround the top segment 8.1 of the sleeve 8. By way of example, the two portions may be identical in an axial section plane containing the axis X. Each portion has a strip of glue, preferably a permanent-tack adhesive.

The sleeve 8 and the second skirt 5 are spaced apart radially by a distance d lying in the range 5 mm to 15 mm, and preferably in the range 8 mm to 12 mm. Preferably, the distance d is substantially equal to 10 mm so as to enable bedbugs to reach the sticky strip 9 and oblige them to cross it in order to go from said sleeve 8 to said second skirt 5.

The sticky strip 9 faces the inner periphery of the second skirt 5, thereby protecting it from dust and also making it easier to take hold of the body 1 in the hand while avoiding any physical contact with said sticky strip 9.

Preferably, the sleeve is shaped in such a manner that the bottom segment 8.2 of the sleeve 8 is not surrounded by the second skirt 5 (or is surrounded in part only by the second skirt 5) so as to make it easier to grasp the sleeve 8 via said bottom segment 8.2, in particular while screwing it onto the first skirt 4 of the body 1 or while unscrewing it. Preferably, a free end of said bottom segment 8.2 is textured to make the sleeve 8 easier to grasp, in particular while screwing it onto the threaded end of 4.1 of the first skirt 4 of the body 1, and also while unscrewing it. By way of example, the free end of said bottom segment 8.2 is textured so that hemispheres 10 are distributed circumferentially on the outer periphery of said free end.

There follows a description of how the device is installed and how it operates.

Before screwing the leg P to a bar of the frame S, the body 1 is engaged on said leg P so that the leg P is received as a snug fit in the first skirt 4 and so that the top face P2 bears against the base 2. The first skirt 4 then covers a portion of the leg P and the threaded rod T of the leg P passes through the hole 3 in the base 2 so as to project from the base 2.

The leg P fitted with the body 1 is then screwed to the bar of the frame S using the threaded rod T until the base 2 of the body 1 comes to press against said bar. The base 2 is then held between the top face P2 of the leg P and the bar of the frame S, and the body 1 is hidden in part by the frame S and is not very visible.

When a bedbug moving on the floor G seeks to reach the frame S by making use of the leg P, it climbs along said leg P and then climbs onto the sleeve 8. Due to its size, in order to reach the second skirt 5, the only option open to the bedbug is to cross the sticky strip 9 where it becomes stuck. Once in contact with the glue, a bedbug normally cannot escape therefrom and thus becomes incapable of reaching the frame S or even of going back down the leg P. The glued bedbug is thus trapped between the sleeve 8 and the second skirt 5 so that it remains hardly visible from outside the body 1, since the sticky strip is masked on the outside by the second skirt 5. Even if a bedbug does manage to reach the second skirt 5 without crossing the sticky strip 9, it cannot crawl along said second skirt 5 because of its smooth surface state.

It is possible that the effectiveness of the sticky strip 9 decreases over time. It may then be useful to replace it.

To do this, it is advantageously not necessarily to disengage the body 1 from the leg P and thus to unscrew said leg P from the frame S. Specifically, it suffices to unscrew the sleeve 8 from the first skirt 4, to remove the sticky strip 9 and replace it with a new strip, prior to screwing said sleeve 8 back onto said first skirt 4.

In order to make it easier to replace the sticky strip 9, the sleeve 8 may be made up of two portions suitable for being secured to each other temporarily, e.g. via a mortise-and-tenon assembly. By way of example, the two portions may be identical in an axial section plane including the axis X. Each half of the sleeve 8 then carries half of the sticky strip 9.

Thus, it is not necessary to lift the frame S in order to separate the sleeve 8 from the leg P, but only to separate the two portions of the sleeve and move each of them away from said leg P.

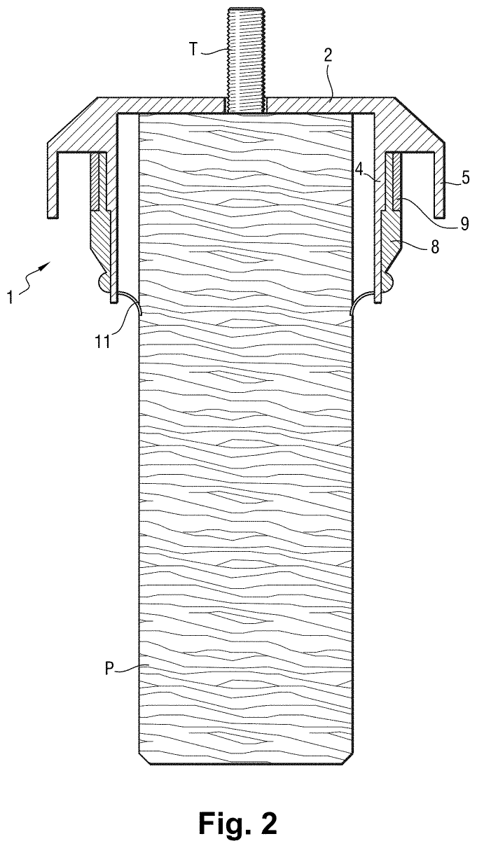

In a first a variant, if the leg P has a diameter smaller than the inside diameter of the first skirt 4, the device may include a sealing element 11 such as a flexible lip gasket arranged at the free end of the first skirt 4 in order to provide sealing between the body 1 and the leg P, thereby preventing bedbugs from entering between said leg P and the first skirt 4 (FIG. 2). In particular, the sealing element 11 may be arranged so as to enable the device to be adapted to a plurality of diameters for the bed leg P.

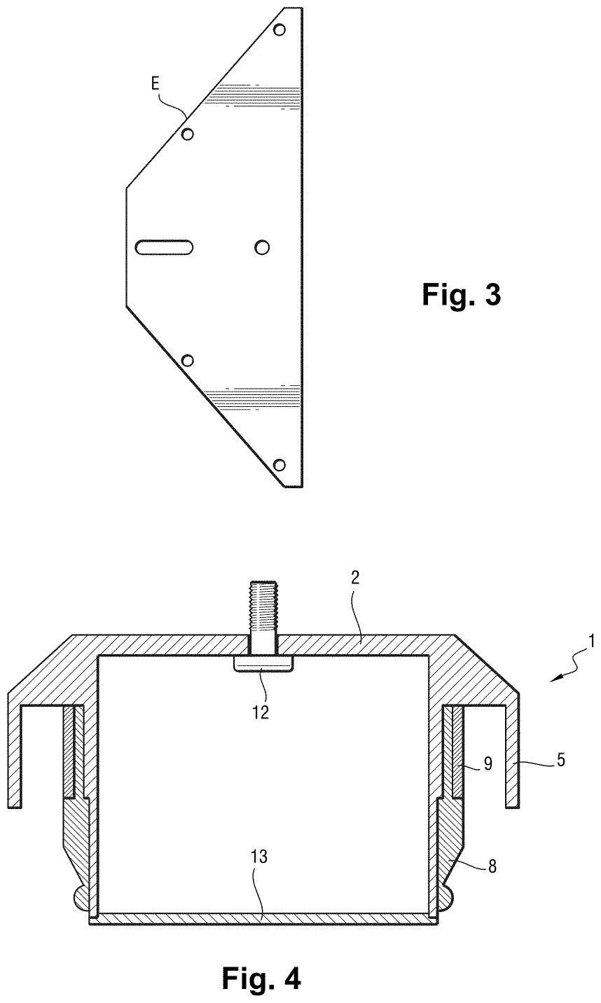

In a second variant, which may be combined with the first variant, the leg P may be spaced apart from the end of the frame S by using a bracket E enabling the screw-fastening of the leg P to be offset towards the inside of the frame S and thus shift the body 1 under said frame S in order to make the body 1 less visible (FIG. 3). Since this type of bracket is well known, it is not described in further detail herein.

Preferably, the device comprises as many bodies 1 as there are legs P screwed into the frame S in order to raise it above the floor G. Thus, the device generally comprises four or five bodies 1, each engaged on a respective leg P of the frame S.

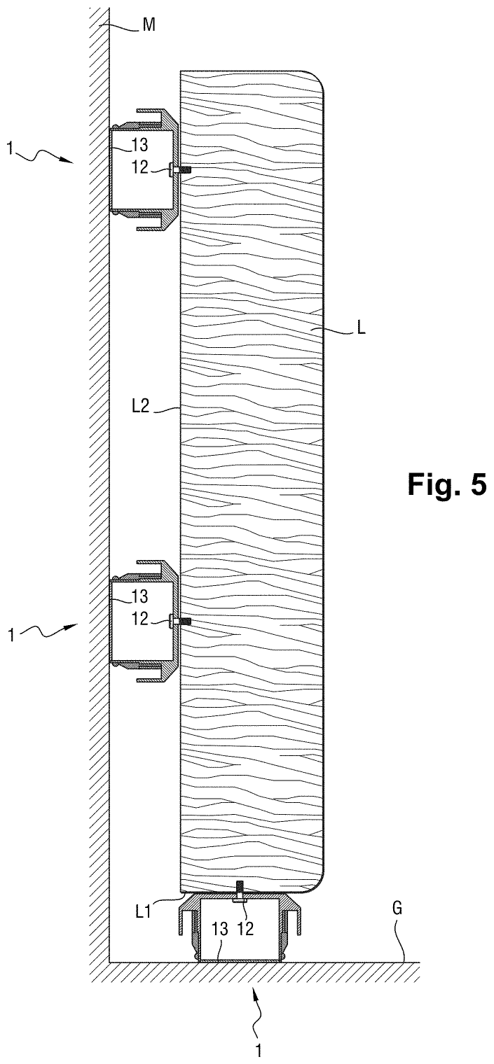

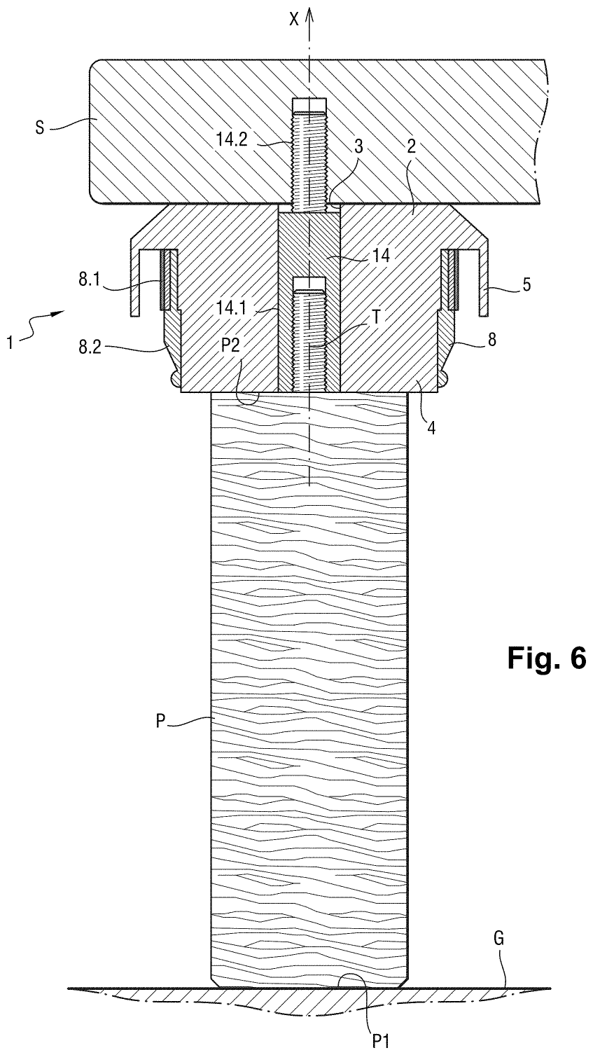

As shown in FIGS. 4 and 5, in a third variant, which may be combined with the first variant and/or the second variant, the bodies 1 may also be used for physically isolating a bed head L from a floor G and/or from a vertical wall M against which the bed head is to rest.

The bed head L has a horizontal face L1 facing the floor G and a vertical face L2 facing the wall M. Each of these faces L1 and L2 rests against one or more bodies 1 having their bases 2 fastened to the bed head L by respective screws 12 passing through the holes in said bases 2.

Each body 1 receives a cover 13 closing the free end of the first skirt 4. The covers 13 are in contact with the floor G or the wall M and they enable the bodies 1 to present respective bearing surfaces of sufficient area to avoid damaging said floor G or said wall M. A piece of felt could also be stuck onto the cover 13 to form a sound insulation layer either between the bed head L and the floor G or between the bed head L and the wall M.

In a fourth variant, which may be combined with the second variant or with the third variant, the first skirt 4 has an inside diameter that is substantially equal to that of the hole 3, such that said first skirt 4 and said hole 3 form a cylindrical housing into which an adapter is inserted by force in order to enable both the leg P to be screwed to the body 1 and also the body 1 to be screwed to the frame S. For this purpose, the adapter 14 has a threaded insert 14.1 for receiving the threaded rod T of the leg P and from which there projects a threaded rod 14.2 that is to be screwed into the frame S. Such an arrangement enables the body 1 to be inserted between the frame S and the leg P regardless of the shape of the leg.

The leg P is initially screwed into the insert 14.1 until the top face P2 of the leg comes to bear against the first skirt 4. The assembly formed by the leg P and the body 1 is then screwed to a bar of the frame S using the threaded rod 14.2 until the base 2 of the body 1 comes to press against said bar. It should be observed that for this purpose the threaded insert 14.1 has a height that is slightly less than the height of the device 1 as defined by the base 2 and the first skirt 4. The entire body 1 is then located between the leg P and the bar of the frame S.

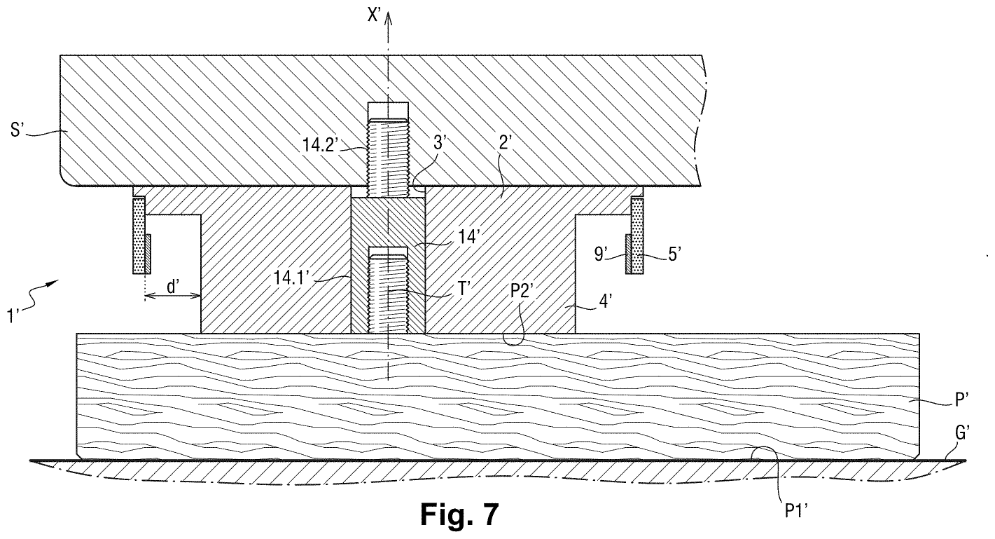

FIG. 7 shows an interception device in a second embodiment of the invention for intercepting bedbugs making use of a bed-raising block P′ in order to reach a bed frame S′. The block P′ is substantially flat and has a horizontal bottom face P1′ for resting on a floor G′, and a horizontal top face P2′ from which a threaded rod T′ projects along a vertical axis X′.

The device comprises a body, given overall reference 1′, that is inserted between the raising block P′ and the frame S′. The body 1′ has a flat base plate 2′ of circular shape that extends in a horizontal plane. At its center, the base 2′ has a hole 3′ of diameter slightly greater than the diameter of the threaded rod T′.

A first skirt 4′ of cylindrical shape extends from the base 2′ and forms a side wall that is circumferentially closed and coaxial about the axis X′. The first skirt 4′ has an inside diameter that is substantially equal to that of the hole 3′, such that said first skirt 4′ and said hole 3′ form a cylindrical housing in which an adapter 14′ is arranged in order to enable both the leg P′ to be screwed to the body 1′ and also the body 1′ to be screwed to the frame S′. For this purpose, the adapter 14′ has a threaded insert 14.1′ for receiving the threaded rod T′ of the leg P′ and also has a threaded rod 14.2′ projecting therefrom that is to be screwed into the frame S′.

A second skirt 5′ of cylindrical shape is releasably connected to the base 2′ and surrounds the first skirt 4′ on the outside. The first and second skirts 4′ and 5′ are coaxial and together with the base 2′, they define an annular groove 6′ having an end wall 7′ that is flat and horizontal. Advantageously, on its outside, the second skirt 5′ presents a surface state that is smooth so that bedbugs find it difficult to climb and crawl on said second skirt 5′. Preferably, at least a portion (but preferably all) of the outside surface of the second skirt 5′ is treated to be non-stick so as to limit any climbing and crawling of bedbugs on said second skirt 5′ even further. For this purpose, the second skirt 5′ in this example is covered in a non-stick coating of Teflon® type.

The second skirt 5′ has an internal surface carrying a sticky strip 9′. By way of example, the sticky strip 9′ is a double-sided glue strip having one face coated in weak glue to enable it to be fastened on the second skirt 5′, and another face coated in strong glue for trapping bedbugs.

In order to make it easier to replace the sticky strip 9′, the second skirt 5′ may be made up of two portions suitable for being secured to each other temporarily, e.g. via a mortise-and-tenon assembly, so as to surround a bottom segment of the base 2′. By way of example, the two portions may be identical in an axial section plane including the axis X′. Each portion has a strip of glue, preferably a permanent-tack adhesive.

The first skirt 4′ and the second skirt 5′ are spaced apart radially by a distance d′ lying in the range 5 mm to 15 mm, and preferably in the range 8 mm to 12 mm. Preferably, the distance d′ is substantially equal to 10 mm so as to oblige bedbugs to cross the sticky strip 9′ in order to go from the first skirt 4′ to the external periphery of the second skirt 5′.

The sticky strip 9′ faces the external periphery of the first skirt 4′, thereby protecting it from dust and also making it easier to take hold of the body 1′ in the hand while avoiding any physical contact with said sticky strip 9′.

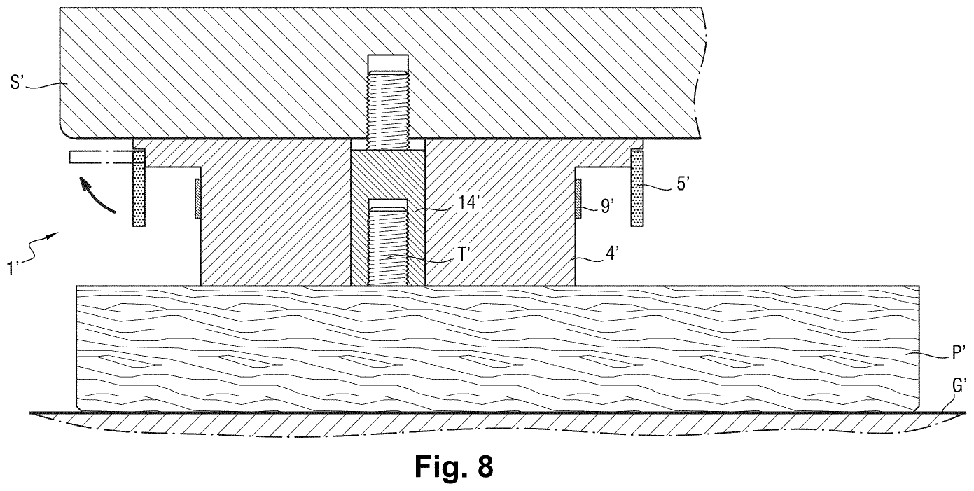

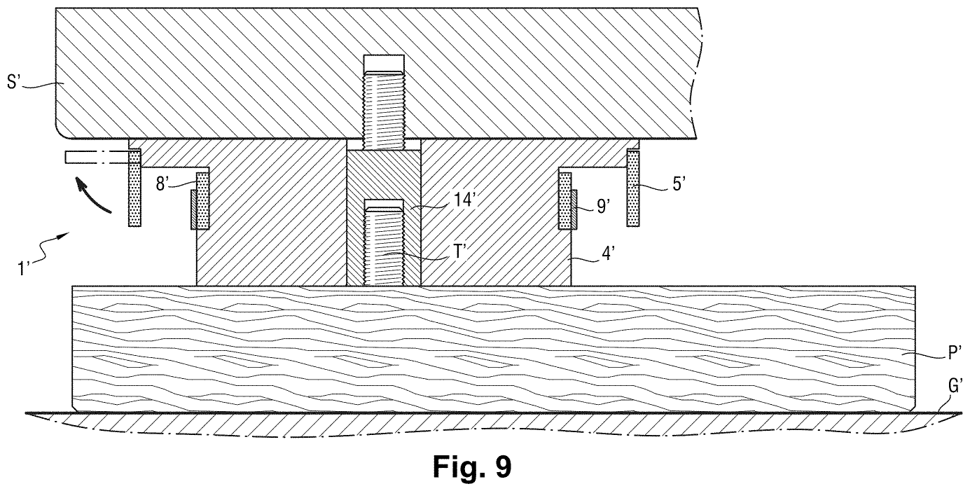

In a first a variant, instead of being carried by the second skirt 5′, the sticky strip 9′ may be carried by a top segment of the first skirt 4′ (FIG. 8). The sticky strip 9′ then faces an inner periphery of the second skirt 5′, thereby likewise protecting it from dust and also making it easier to take hold of the body 1′ in the hand while avoiding any physical contact with said sticky strip 9′.

In order to make it easier to replace the strip 9′, the second skirt 5′ may be made in two portions, as above, or indeed it may be elastically deformable (at least locally) so as to allow the second skirt 5′ to be pivoted temporarily relative to the base 2′ (shown in chain dotted lines).

In a second variant, the sticky strip 9′ could also be carried by an outside surface of a sleeve 8′ is attached, e.g. by clipping, on a top segment of the first skirt 4′. The sleeve 8′, and thus the sticky strip 9′, may be made of two portions suitable for being temporarily secured to each other, e.g. via a mortise-and-tenon assembly, so as to surround the top segment of the first skirt 4′.

Naturally, the invention is not limited to the embodiment described but covers any variant coming within the ambit of the invention as defined by the claims.

Although, above, the device is described for intercepting bedbugs, it can also be used for intercepting any crawling insect that cannot fly or jump. Depending on the size of the insect to be intercepted, the distance d between the sticky strip 9 and the second skirt 5 may be greater than or less than 10 mm.

The end wall 7 of the base 2 of the device 1 of the invention need not necessarily be flat and horizontal.

Although, above, the device is described in application to a bed frame S, s′ or to a bed head L, it can equally well be used with any other piece of furniture optionally provided with legs P or with raising blocks P′ (couch, sofa, sideboard, TV cabinet, . . . ).

The device can equally well be fitted on legs of shapes different from those described, in particular on legs of section that is square or rectangular.

Other fastening means, other than screw fastening, could be envisaged for fastening the sleeve 80 temporarily to the first skirt 4 (clipping, quarter turn, . . . ).

Although above, the body is generally cylindrical in shape, other shapes could be envisaged, in particular in order to match the shape of the leg (rectangular block, oval, . . . ). For example, when the leg is of square section, the first and second skirts of the device could in particular also be of square section so as to be closer to the outside surface of the leg, providing said first and second skirts are concentric.

Although above, the sleeve 8 is attached to the first skirt 4, it could equally well be attached to the second skirt 5.

Although above, the adapter 14, 14′ is arranged to enable the leg P or the raising block P′ to be screwed to the body 1, 1′, it could, more generally, be arranged to enable the leg P or the raising block P′ to be fastened to the body 1, 1′, e.g. by clip fastening or by interlocking (the rod T, T′ would then not be threaded and would be substantially smooth).

Similarly, although above the adapter 14, 14′ is arranged to enable the body 1, 1′ to be screwed to the bed frame S, S′, it could, more generally, be arranged to enable the body 1, 1′ to be fastened to the frame S, S′, e.g. by clip fastening or by interlocking.

1. A device for intercepting crawling insects, the device comprising at least one body, itself comprising:
a base for resting against a piece of furniture and having a hole at its center;
a first skirt extending from the base so as to form a circumferentially closed side wall;
a second skirt surrounding the first skirt externally so that an outer periphery of the side wall faces an inner periphery of the second skirt; and
at least one sticky strip arranged on the outer periphery of the side wall or on the inner periphery of the second skirt.

2. The device according to claim 1, wherein the sticky strip is a glue-based strip.

3. The device according to claim 1, wherein the first and second skirts (4, 5; 4′, 5′) are cylindrical in shape.

4. The device according to claim 3, wherein the first and second skirts are spaced apart radially by a distance of not less than 10 mm.

5. The device according to claim 1, wherein the sticky strip is carried by a sleeve attached to the body.

6. The device according to claim 5, wherein the sleeve is screwed to the body.

7. The device according to claim 5, wherein the sleeve is clipped to the body.

8. The device according to claim 5, wherein the sleeve is made up of two portions that can be separated.

9. The device according to claim 8, wherein the two portions of the sleeve are secured to each other temporarily by a mortise-and-tenon assembly.

10. The device according to claim 5, wherein a distal end of the sleeve is textured.

11. The device according to claim 1, including a sealing element arranged to provide sealing between the body and an element of the piece of furniture arranged in said body.

12. The device according to claim 1, including a cover closing a free end of the body remote from the base.

13. The device according to claim 1, wherein the hole and the first skirt form a cylindrical housing receiving an adapter arranged to enable a first element to be screwed to or interlocked with the body, and enabling the body to be screwed to or interlocked with a second element.

14. The device according to claim 13, wherein the adapter comprises a threaded insert for receiving a threaded rod of the first element and from which there extends a threaded rod for screwing to the second element.

15. A piece of furniture including a face and at least one device according to claim 1, wherein the device is arranged in such a manner that the base rests against the face.

16. A bed comprising a frame and at least one bed leg fastened to the frame and having sandwiched between them a device according to claim 1.

17. The bed comprising a frame and at least one raising block having sandwiched between them a device according to claim 13.

18. A bed head having a first face arranged to face a floor, a second face arranged to face a wall, and at least one device according to claim 14, wherein the device is arranged in such a manner that the base of the body rests against one or the other of the first and second faces.
